(19) United States
(12) Patent Application Publication
(10) Pub. No.: US 2014/0143133 A1
(43) Pub. Date: May 22, 2014

(54) Method and System for Private Association Rating System

(71) Applicants: Sara Benson, Chicago, IL (US); Jared Saunders, Chicago, IL (US); Whitney Nelson, Chicago, IL (US)

(72) Inventors: Sara Benson, Chicago, IL (US); Jared Saunders, Chicago, IL (US); Whitney Nelson, Chicago, IL (US)

(21) Appl. No.: 14/071,860

(22) Filed: Nov. 5, 2013

Related U.S. Application Data
(60) Provisional application No. 61/729,140, filed on Nov. 21, 2012.

(51) Int. Cl. G06Q 40/00

(52) U.S. Cl. CPC G06Q 40/025
USPC 705/38

(57) ABSTRACT

A method and system for obtaining a numerical expression based on statistical analysis of the risk, quality and performance of a private association, to represent the creditworthiness and health of that private association. Users of the system can use the resulting score number in assisting with purchasing or investment decisions.

This application claims priority to U.S. Provisional Patent Application Ser. No. 61729140, filed Nov. 21, 2012, to the extent allowed by law.

### BACKGROUND OF THE INVENTION

### Field of the Invention

The present invention pertains generally to a method providing a score reflecting the creditworthiness and health of a private association, i.e., a home owners association, such as a condominium board, or the like. More specifically, the present invention provides a method to evaluate the risk, quality and performance of a private association and returns a numerical expression of a private association rating score (PAR score) number based on the evaluation. Users of the system can use the resulting score number in assisting them with purchasing or investment decisions.

### BACKGROUND OF THE INVENTION

Many properly calculated scoring mechanisms are being used to reduce risk and take the guesswork out of decision-making. Standards and protocols have been used for decades by companies such as FICO, Dun and Bradstreet, Experian, Equifax, and TransUnion.

FICO stands for Fair Issac Corporation, which was founded in 1956 by Bill Fair & Earl Isaac and first headquartered in San Rafael, Calif. A FICO score is a three digit number between 300 and 850 given to individuals which aims to give a snapshot of an individual's credit risk. The area of use of the FICO score is mostly in the USA, but the scoring system is also occasionally used in Canada and other regions. The FICO score is calculated by using statistical analysis of an individual's credit files.

Each of the three credit reporting agencies—Equifax, Experian, and TransUnion, have a different name for their FICO scores. Experian uses the Fair Issac Score/Model, and the score range is 330-850. Equifax uses the BEACON® Score model, and the score range is 300-850. TransUnion uses the Empirica® model, which has a score range of 150-934.

The Data Universal Numbering System (DUNS or D-U-N-S), is a system developed and regulated by Dun & Bradstreet (D&B), that assigns a unique numeric identifier, referred to as a “DUNS number” to a commercial business entity. The DUNS number system was introduced in 1963 to support D&B's credit reporting practice, and is presently a common standard used worldwide.

A recent service provided by Freddie Mac implements “Home Value Explorer” (HVE), an Automated Valuation Model (AVM) that generates a real estate property value estimate within seconds. A “confidence score” produced by Core Logic—one of Freddie Mac's partners—is used in many AVMs to assist in scoring the estimated reliability, as each AVM uses proprietary algorithms and arrives at its own estimate of value.

Standard & Poor's is an American financial services company and is a division of The McGraw-Hill Companies that publish financial research and analysis on stocks and bonds. The company rates borrowers on a scale from AAA to D. For some borrowers, the company may also offer guidance (termed a “credit watch”) as to whether it is likely to be upgraded (positive), downgraded (negative) or uncertain (neutral). In 2008, Standard and Poor's, in response to Wall Street failures, developed a GAMMA (Governance-Accountability, Management Metrics and Analysis) score designed for equity investors, which score assesses, in particular, corporate governance risk. A GAMMA score reflects S&P's opinion of the relative strength of a company's corporate-governance practices as an investor protection against potential governance-related losses of value or failure to create value. GAMMA is designed for equity investors in emerging markets and is focused on non-financial-risk assessment, and in particular, assessment of corporate-governance risk. For the GAMMA score, the score range is 1-10.

Another related product on the market is from Carfax, Inc. Carfax, Inc. is a commercial web-based service that supplies vehicle history reports to individuals and businesses on used cars and light trucks for the American and Canadian marketplaces. The Carfax Vehicle History Report is the company's core product. Users purchase either a single report or create an account for building multiple reports for different vehicles, allowing consumers to utilize Carfax over a period of time as they search for a vehicle. Additionally, buyers can request Carfax reports for free from auto dealers who offer Carfax services, and some automakers routinely provide Carfax reports as part of their pre-owned vehicle programs. Carfax, however, does not provide a numerical score for their ratings.

An individual's credit score is determined based on several types of information. This information includes personal information such as the value of a major asset, credit information such as an account balance, public record information such as bankruptcy, and inquiry information such as a request for a credit report. There are different methods of calculating credit scores and the credit bureaus all have their scores and scoring system. The scores are used by many mortgage lenders that utilize a risk-based system to determine the possibility that the borrower may default on financial obligations to the mortgage lender.

Today, one in five Americans—an estimated 60 million residents—live under the rule of a homeowners association (HOA), which includes condominiums, cooperative apartments and many multifamily and single-family residences. Nationwide, a total of 24.4 million homes are governed by thousands of homeowner associations. As of 2009, according to the Community Association Institute (2010) and the U.S. Census, there were 305,400 homeowner associations in the U.S. More than 1.7 million people serve on association boards across the country. For the past 20 years, more than 80 percent of newly constructed homes in the U.S. are in association communities. The total annual operating revenue for homeowner associations is more than $41 billion a year.

An October 2011 survey conducted by the Community Association Institute (CAI) found that 65 percent of homeowners' associations have delinquency rates higher than 5 percent. In 2005, only 19 percent of homeowners' associations had delinquency rates higher than 5 percent. A September 2011 survey conducted by the CAI found that more than 50 percent of the nation's homeowner associations now face “serious financial problems.”

According to the National Association of Realtors, in a typical real estate market, the average homeowner relocates every seven years—or approximately 3,485,714 HOA transactions per year. Many of these transactions will take place in communities that present high risks to lenders, private mortgage insurance companies and insurance carriers.

Traditional home purchases require the “two Ps” to meet certain credit worthiness and appraisal standards in order to close: The Purchaser and the Property. What is not rated, appraised or scored, however, is the community association itself—either fiscally or physically.

Because of the inherent self-governed “private” nature of community associations, there is little or no government oversight as to how a proper association should be run and many—if not most—associations are poorly functioning. The health of the community as a whole is more important in making a wise lending or insuring decision that the individual home within the development. Thus, a third “P” is necessary to rate the community association—the Private Association Rating, or PAR score.

Currently, there exists no standardized model to evaluate and score the fiscal health, safety, overall governance conduct, and security of a private association such as a condominium or co-op homeowners association, based on multiple factors. What is needed are a method and system that can evaluate the creditworthiness, governance, and financial health of a homeowners association. An appropriate rating system will reflect an association's assessment delinquencies and foreclosure rates, as well as lawsuits and known unabated health hazards. Just as lenders make lending decisions based on a person's credit scores, banks, insurance companies, and home purchasers can use the PAR scores to help with their decision making process. It is expected that primary target users of the PAR scores will be lenders making primary or secondary loans on properties located within a homeowners association, and insurance companies providing insurance to homeowners associations (in the form of Directors and Officers, errors and omissions, liability, fidelity & Crime and Property insurance, respectfully). It would also be expected that the ancillary target markets for the PAR scores are the purchasers of real estate located within a homeowners association, real estate brokers, and homeowner associations themselves.

### DESCRIPTION OF THE PRIOR ART

The prior art discloses several rating systems but fails to disclose the rating system of the present invention. U.S. Published Patent Application No. 2003/0177071 discloses a system and method for compiling, accessing and providing community association disclosure information, lender information, community association document information and update information. The disclosed method includes: compiling community association information regarding a plurality of community associations into a community association database; extracting the information necessary to complete the sale, transfer, financing or refinancing or to mange the community association from the database, and providing to an authorized user the information necessary to complete the sale, transfer, financing, or refinancing or to manage the community association. The disclosed system, however, does not report on reserves or reserve fund studies. The disclosed system also does not output a numerical expression of the creditworthiness or health of an association.

U.S. Published Patent Application No. 2008/0133385 discloses an Internet clearinghouse for homeowner association information. The reference discloses a homeowner association database which allows access to homeowner association data by a plurality of remote computer users through a graphic user interface which allows activation of a plurality of homeowner association participant modules, each matched to a portion of the homeowner association data stored in the homeowner association database relevant to the homeowner association participant. The disclosed system compiles a miniscule set of data compared with the present invention and process the information in a different way. More importantly, the disclosed system does not output an evaluation score.

U.S. Pat. No. 7,958,011 discloses a method to obtain community association data in a direct, efficient manner. By receiving an order directly from the requestor and building the order using a master questionnaire which includes questions and answers that may be incorporated into the sub-questionnaires (products), the association data may be sent to the requestor directly. While the disclosed method focuses only on the information gaining process, it does not discuss the analysis of the information. The disclosed method also does not return an output number for the evaluation of the private association.

### SUMMARY OF THE INVENTION

The present invention provides a method and system for obtaining a numerical expression based on statistical analysis of the risk, governance quality and performance of a private association, to represent the creditworthiness and health of that private association. Users of the system can utilize the resulting score number in assisting them with purchasing, investment or insurance decisions, among others.

The system has a database covering all 305,400 communities and their homeowner associations throughout the United States. Every association will be assigned a unique Permanent Identification Code (PIC.) The system analyzes more than 144 data sets to determine a Private Association Rating (PAR) score. The PAR scores will be used by lenders, private mortgage insurance companies and insurance carriers to minimize loan default risks and claims risks.

The data used for the system's analysis include direct investigations and interviews with association directors and property managers, as well as on-site inspections of the communities. Basic information will include the number of units in a building and the number of buildings in the association, actual age of the buildings, age of the roof, and other pertinent factors.

Financial reporting will include verification of operating and reserve account monies/reserve fund studies. Twenty-four months of board minutes will be examined for adherence to standard accepted business protocol procedures and to ensure against unexpected and costly special assessments that have been discussed by the association's directors, but not yet levied at the time of a sale or proposed sale. A running history of past levied special assessments will also be analyzed. A check for dates of past reserve studies and dates of past financial audits will also be analyzed. Additional sources include monitoring corporate filings such as lawsuits, judgments, and bankruptcies.

After the information is gathered, the evaluation module in the system will assign a value to the corresponding condition. The assigned value reflects the relative quality of the association or the property. The better the quality, the higher the plus value will be assigned, and vice versa. There are generally five or less levels of values given for each factor. After the values are assigned to all of the at least 144 factors, the values are calculated in the calculating module to become the final PAR score.

The PAR scores will be shown as numbers indicating the creditworthiness and health of an association. The highest achievable PAR score will be a predetermined number and will indicate the most creditworthy and healthy associations. Lower ratings will reflect an association with high assessment delinquencies and foreclosure rates, as well as lawsuits and known unabated health hazards.

Users of the system can access the score report online to view the scores and other information of the association. The system generates different types of reports containing different levels of information based on the requesting user's status. Premium users can obtain more details about the factors affecting the association's score. The rating system will create unprecedented transparency and reduce liability not only to lenders and insurance companies, but to consumers as well. The database will systematically update the scores when a critical factor changes, such as when there is a loan made, or when the user such as an insurance company requests an update. Low scoring associations will work to raise their ratings and high scoring associations will make the effort to maintain their ratings.

For lenders, the PAR score will serve as a complete appraisal and evaluation rating the overall health, governance, safety, security and creditworthiness of the homeowner association. For insurance carriers, the PAR score will assist in underwriting directors and officers, liability, fidelity/crime coverage, fire and casualty and other insurance.

The PAR score for lenders and insurance companies will solve the problem of distinguishing a healthy association from a diseased one—and reduce the liability of lending or insuring in high-risk associations. Consumers will buy with confidence by receiving a PAR score.

### BRIEF DESCRIPTION OF THE DRAWINGS

FIG. 1 is an overall structural illustration of the user accessing the private association rating system through internet access.

FIG. 2 is a flowchart showing the data coordinator of the private association rating system processing the incoming request and gathering the output registry report.

FIG. 3 is a flowchart showing the data gathering and entry procedure.

### DETAILED DESCRIPTION OF THE ILLUSTRATED EMBODIMENTS

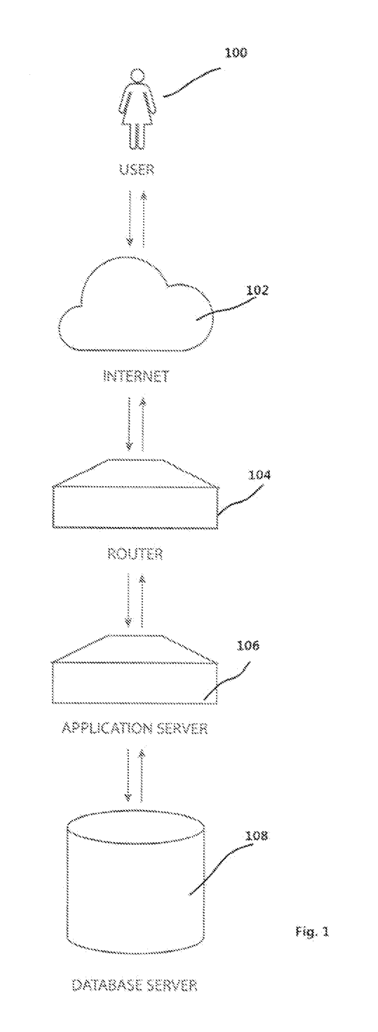

FIG. 1 illustrates the structure of a user 100 accessing the information stored in the system database server 108. A user 100 is a client of the present PAR system that accesses the information provided by the PAR system through internet access 102. The user 100 gets connected with the internet 102 and sends/receives information from the internet 102. The delivered data packet may comprise information other than the user 100's request, such the user 100's authorization status and limitations on the levels of information available. A router 104 then connects the data line on the user 100 end with the data line on the database server 108 end. The application server 106 receives the data packet containing the user's 100 request from the router 104 and delivers the data packet to the database server 108. The user 100 sends a request to be processed by the application server 106 through the internet 102 to request the information provided by the PAR system. The request from user 100 is included in a data packet and delivered to router 104. The application server 106 runs the programming code of the web service interface of the PAR system. The application server 106 authenticates the user 100's identity, processes the user 100's authorization status, and limitations on the levels of information available to the user 100. The application server 106 also calls for the database server 108 to prepare the complete registry report that is eventually delivered to the user 100.

After receiving the data packet from user 100 through the application server 106, the database server 108 retrieves the pertinent information based on the request contained in the data packet. The PAR system then generates a registry report for the user 100 based on the request, the user's authorization status and limitation on the accessible levels of information. The generation of information stored in the database server will be further explained in this document. The database server transmits the completed registry report to the user 100 via the application server 106, router 104, and the internet 102.

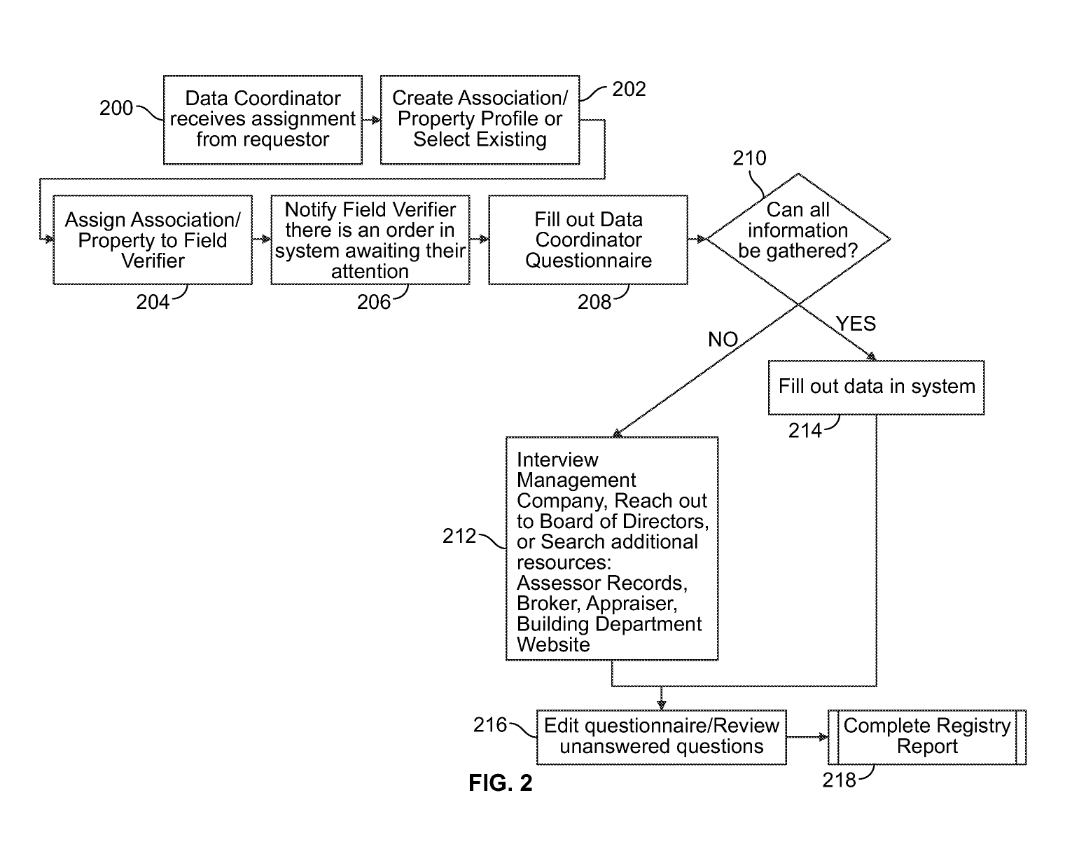

The PAR system's main database server 108 stores information gathered by the system's information verifier from various different communities and their homeowner associations throughout the United States. As FIG. 2 illustrates, the PAR system provides a data coordinator to control, organize and edit information stored in the database server 108. The system data coordinator receives a request for the requestor regarding an association at step 200. The requestor can be a user 100 in FIG. 1, or can be any other entity or individual authorized to make the request for information regarding a specific homeowner association.

At step 202, the system determines whether the requested association has a file that is already created in the system's database. If the association's file is already in existence, the system will proceed with the information generating or editing process. When the system determines that the requested association does not have a file in the system's database, the system will create a new file for the association and proceed with the information generating or editing process.

The PAR system will assign the requested association to a field verifier for verification at step 204. The assigning process is completed by the system through a location proximity filter. The location proximity filter searches for field verifiers within proximity of the assigned property's location. In one embodiment, the filtering process is done by comparing zip codes of the property and the verifiers' current location information updates. Once the qualified verifiers are selected, the PAR system sends out a message to the selected verifiers regarding the basic information of the association and/or property to be inspected. The outgoing message can be formatted as an email or text message and sent through a wireless network to the verifiers' mobile device. The verifiers receive the message will respond to the system indicating if he or she will take the assignment. The system will assign the verification job to the verifier who responds to the system first.

Once the system assigns the job to a verifier, the system will notify the assigned field verifier at step 206. In one embodiment of the present invention, the system will also send a notification to all the qualified verifiers determined in step 204 that the job has been taken. The assigned field verifier will obtain the standard questionnaire from the system. In one embodiment, the standard questionnaire is delivered to the assigned verifier's mobile device. The assigned verifier fills out the standard questionnaire as he/she inspects the property and association at step 208. A detailed description of the questionnaire filling process will be disclosed in this document. The verifier is required to follow the instructions stated in the questionnaire and answer the questions based on his/her observation and inspection of the association and the property.

The PAR system will then decide whether all information can be gathered at step 210. If all the information required to fill out the questionnaire can be gathered, the data will be provided and stored in the PAR system at step 214. When the system detects information that has not been obtained yet, it will send notifications and requests to the field verifier at step 212. These notifications and requirements comprise interviews with the management company, reaching out to the board of directors, or searching additional resources, such as assessor, broker, appraiser, and building department records and website.

When the questionnaire is filled out and transmitted back to the system's database, the data coordinator will edit the completed questionnaire or review the unanswered questions at step 216. The completed questionnaire will be graded by the evaluation module. A complete registry report will be created at step 218.

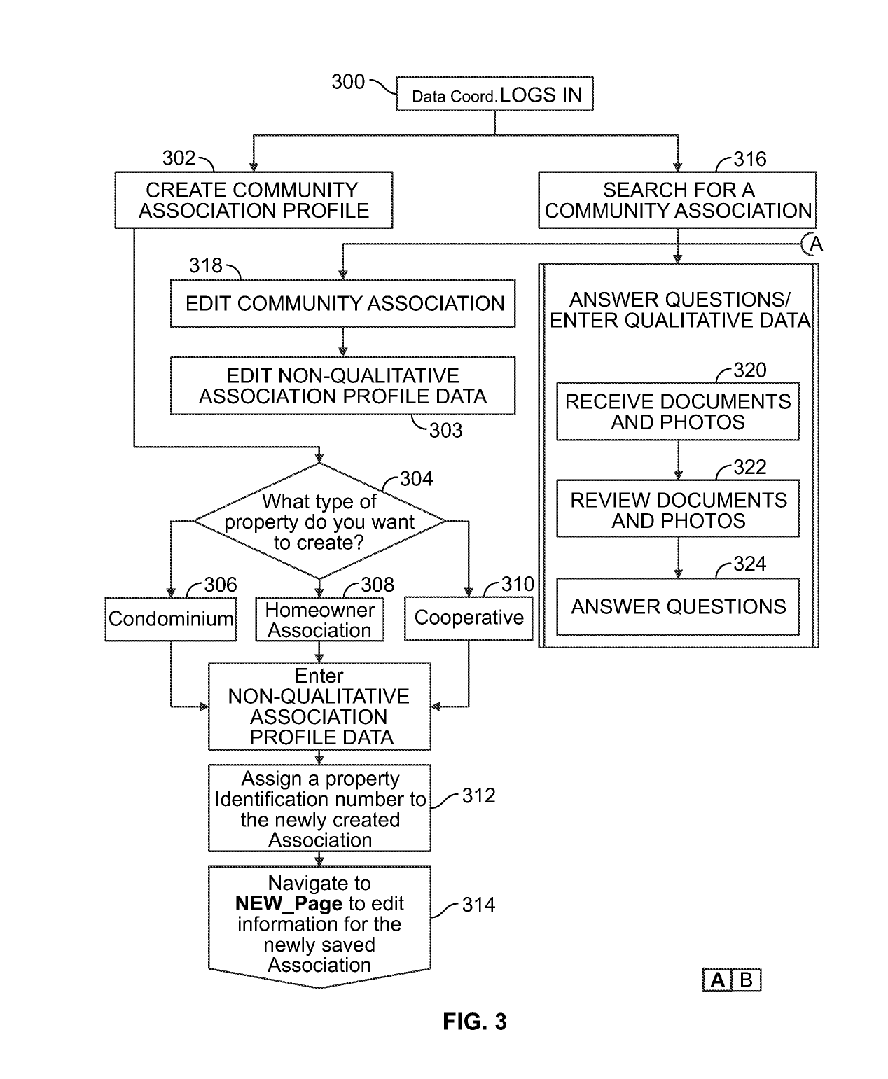

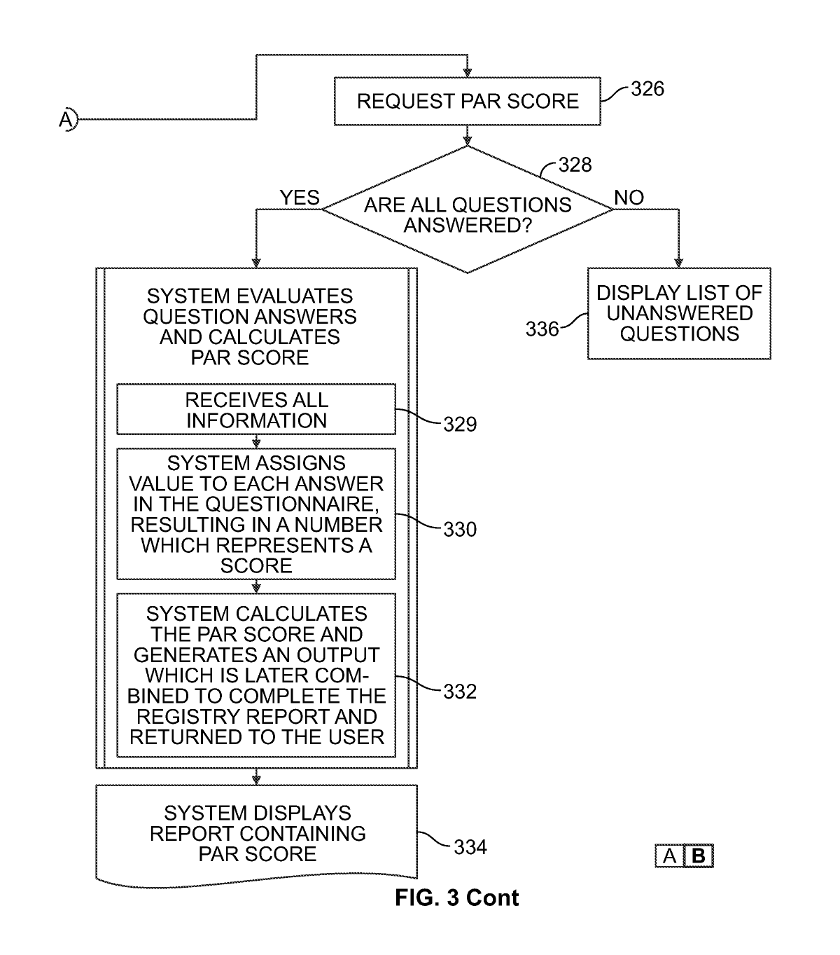

FIG. 3 shows the process flow of the data coordinator searching and editing a community association's profile. An authorized user such as the data coordinator will provide authentication information such as user name and pass code to log in to the system at step 300. The data coordinator can log in on a mobile. But other kinds of computer devices can be used for the log in and information gathering process as well. The data coordinator can create a new file for a community association that is not yet registered in the PAR system at step 302. A newly created file is defined by selecting a type of property at step 304. The data coordinator will pick and choose from condominium 306, homeowner association 308, and cooperative property 310 to define the type of property identified in the newly created file. The system will assign a property identification number to the newly created property and/or association at step 312. This identification number will be used in the future to identify this specific property for information collecting, editing, and registry report creating purposes. After the identification number is assigned to the property, the PAR system will navigate the verifier to a new information page to edit information for the newly created property at step 314.

Once the property is registered in the system, the property and associated association can be searched either by the assigned identification number, or by the name of the property at step 316. The registered community association's profile can be edited at step 318. The PAR system requests non-qualitative association profile data from the data coordinator at step 303. The non-qualitative association profile data to be edited in step 303 are the index data such as name, address or nature of the property. These data are non-qualitative because they are not evaluated or graded in the final evaluation process. These data are more relevant to property identification and indexing rather than the quality of the property and trustworthiness of the community association.

While the field verifier generating and responding to external physical related questions during the information collecting process, the data coordinator is required to answer questions and enter internal qualitative data when he/she is inspecting the association and/or property. The external physical related questions processed by the field verifier include such as condition of the premises, observation of landfills, proximity of high-power tension lines etc. Internal qualitative data may include answers to questions such as owner occupancy rate, amount of money in reserves as compared to annual income etc. The system will request documents to be evaluated by the data coordinator and photos taken by the verifier at step 320. The requests for taking photos include standardized and specific instructions. The field verifier will take the photos following the standardized instructions from the system as to where and what to take, and how many photos are taken. For example the system can require the verifier to take one photo from the exterior front, exterior entrance, exterior rear and street scene. Each of these photos will be uploaded to the main system database and be evaluated and/or made available to comprise the complete registry report.

The data coordinator oversees all aspect of the questionnaire. After the photos are taken and documents are uploaded the data coordinator can review the documents at step 322 to make sure the related information is accurate. The uploaded documents including declaration or covenants, conditions and restrictions, bylaws, rules and regulations, budgets, minutes, lawsuit disclosure statement, special assessment disclosure statement, special assessment disclosure statement, director's code of ethics statement, certificate of insurance, estoppel certificate, PAR score questionnaire. The standard questionnaire is then given to the data coordinator at step 324.

The questions in the questionnaire are specifically designed for obtaining a numerical expression based on statistical analysis of risk, governance quality and performance of the community association, to represent the creditworthiness and health of the communication association and the property. Instead of just doing an inspection and analysis of the property, the questions in the questionnaire also focus on the management and performance of the affiliated home owner associations or other types of associations. In one embodiment the questionnaire will include more than 144 questions, relating to the basic information such as number of units in each building and the number of buildings in the association, actual age of each building, age of the roof, and other pertinent factors. It will also include questions requiring inspection of the financial reporting of the association, such as verification of operating and reserve account monies/reserve fund studies. Twenty-four months of board minutes will be examined for adherence to standard accepted business protocol procedures and to ensure against unexpected and costly special assessments that have been discussed by the association's directors, but not yet levied at the time of a sale or proposed sale. A running history of past levied special assessments will also be inspected and analyzed. A check for dates of past reserve studies and dates of past financial audits will also be analyzed. Additional sources include monitoring corporate filings such as lawsuits, judgments, and bankruptcies. Combining the inspections to the physical features of the property with the inspections to the performance of the association creates an accurate evaluation for the investors to make their decisions.

These questions are designed to be answered by either yes-or-no, or by score scales. Each of these answers will be stored to the system database waiting for the evaluation module to assign a value to each of the answered questions. The values will be calculated to constitute a PAR score. The PAR score can be requested by the data coordinator or system at step 326. When a PAR score is requested, the system will determine whether all questions are answered at step 328. If all the questions are answered completely, the system will call the evaluation module to start to evaluate the question answers and calculate the PAR score starting from step 329 to step 334.

The evaluation module first receives all the information collected and evaluations provided by the field verifier at step 329. The PAR system then assigns value or values to each answer in the questionnaire. The assigned value represents the score that each answer to a question receives. This process will provide the basis for the PAR system to use the resulting scores in determining the creditability and healthiness of different community associations. After the evaluation is completed, the system calculates the PAR score of the selected association at step 332 and displays the score 334. In one embodiment, the system calculates the PAR score by combining the scores from each answer to the questions in the questionnaire. The PAR score can also be presented with other information selected by the system based on the request the system received, thus forming a complete registry report to help the end user clients at step 332. The end user clients may utilize the resulting score number, along with the information contained in the complete registry report to assist with purchasing, investment or insurance decisions. If not all the questions are answered by the verifier during the inspecting or information filing process, the system will display a list of the unanswered questions at step 336.

The questions contained in the questionnaire used in the system can be designed in several different ways to reflect the concerns or potential negative external influences or unusual sightings that are easily overlooked by a regular consumer or investor if he/she is inspecting the property or association by himself/herself.

The registry report contains a numerical expression of the evaluation of the examined association based on the information gathered by the verifier sent out by the system. The registry report also contains other relevant information comprising the top and bottom predetermined number of reasons for the rise or drop of the rated association's scores. Based on different requests from the user, the PAR system provides different levels of information and illustrations to help the users to understand the overall condition of a community association. The numerical expression included in the completed registry report is a straightforward indication of the condition of a community association. PAR scores in different ranges can be grouped to a scale from AAA-DD. Both the scores and scales can be used to conveniently compare more than one community associations.

While one particular embodiment of the method and system for private association rating system of the present invention has been shown and described, it will be apparent to those skilled in the art that changes and modifications may be made without departing from the true spirit and scope of the present invention. It is the intent of the appended claims to cover all such changes and modifications as fall within the true spirit and scope of the invention.

1. A system for rating community associations, comprising:
an application server interacting with a user of the system;
a database server storing at least one community association identity and at least one community association evaluation factor, said database server transmitting a standardized questionnaire containing said at least one community association evaluation factor and standardized instructions to a field verifier;
said field verifier receiving said standardized questionnaire from said database server;
said field verifier conducting an inspection of the association and at least one property of the association, and generating information regarding said at least one community association evaluation factor and responding to said at least one evaluation factor in compliance with the standardized instructions;
an evaluation module assigning values to the at least one evaluation factor responses, said values reflecting the quality of the association;
a calculation module calculating a score value based upon said assigned values and outputting the score value for said at least one private association.

2. The system of claim 1, wherein:
a data coordinator oversees and edits said standardized questionnaire.

3. The system of claim 1, wherein:
said application server receives the user's authentication information and grants access to the system based on the user's authentication information.

4. The system of claim 1, wherein:
said at least one community association evaluation factor comprises a physical condition of at least one property and performance of at least one managing entity for said at least one property.

5. The system of claim 4, wherein:
said physical condition of said at least one property is selected from the group consisting of the condition of the property, observation of landfills, and proximity of high-power tension lines.

6. The system of claim 4, wherein:
said performance of at least one managing entity is selected from the group consisting of owner occupancy rate, amount of money in reserve as compared to annual income, financial reporting, twenty-four months of board minutes, running history of past levied special assessments, check for dates of past reserve studies and dates of past financial audits, and corporate filings including lawsuits, judgments, and bankruptcies.

7. The system of claim 2, wherein:
said data coordinator creates a new profile for said at least one association to be stored in said database server.

8. The system of claim 4, wherein:
said data coordinator assigns said at least one property to said field verifier.

9. The system of claim 1, wherein:
said calculation module calculates said score value by combining the assigned values from each answer to the questions in the standardized questionnaire.

10. The system of claim 1, wherein:
said score value for said at least one community association combines with said information regarding said at least one community association evaluation factor and forms a registry report.

11. The system of claim 3, wherein:
said system combines different levels of information based on the user's authentication status information.

12. The system of claim 10, wherein:
said system transmits said registry report to said user.

13. A method for rating community associations, comprising:
a. assigning a permanent identification code to at least one community association in a database server;
b. generating at least one evaluation factor of said at least one community association in said database server;
c. said at least one evaluation factor transmitted by said database server to a field verifier;
d. said field verifier conducting an inspection of the association and at least one property with the association, and generating information regarding said at least one evaluation factor in a response;
e. saving the response from said field verifier regarding said at least one evaluation factor pertaining to said at least one community association into a database for an evaluation module;
f. said evaluation module evaluating said at least one evaluation factor and assigning an evaluation value to each of the factors evaluated;
g. a calculation module calculating said assigned evaluation values to form at least one output rating score; and
h. corresponding said at least one output rating score with said permanent identification code in said database server to reflect the quality of said at least one community association.

14. The method of claim 13, including:
an application server authenticating the authorization of a user, said application server interacting with the user of the method.

15. The method of claim 13, including:
verifying and editing said response by a data coordinator.

16. The method of claim 15, including:
assigning said at least one property to said field verifier by said data coordinator.

17. The method of claim 13, including:
said calculation module calculating said assigned evaluation by combining the assigned values from each response to said at least one evaluation factor.

18. The method of claim 13, including:
said calculation module generating a registry report including said at least one output rating score and response to said at least one evaluation factor.

19. The method of claim 18, including:
delivering said registry report to said user.

20. The method of claim 13, wherein:
said at least one evaluation factor comprises a physical condition of said at least one property selected from the group consisting of condition of the property, observation of landfills and proximity to high-power tension lines.

21. The method of claim 13, wherein:
said at least one evaluation factor comprises a performance factor of said at least one community association selected from the group consisting of owner occupancy rate, amount of money in reserve as compared to annual income, financial reporting, twenty four months of board minutes, running history of past levied special assessments, check for dates of past reserve studies and dates of past financial audits, and corporate filings including lawsuits, judgments, and bankruptcies.
